(19) United States
(12) Patent Application Publication
(10) Pub. No.: US 2015/0055211 A1
(43) Pub. Date: Feb. 26, 2015

(54) REWORKABLE FILTER STRUCTURE OF INFRARED TOUCH MODULE

(71) Applicant: ASIA VITAL COMPONENTS CO., LTD., New Taipei City (TW)

(72) Inventor: Chih-Wei Chang, New Taipei City (TW)

(73) Assignee: ASIA VITAL COMPONENTS CO., LTD., New Taipei City (TW)

(21) Appl. No.: 13/974,012

(22) Filed: Aug. 22, 2013

(51) Int. Cl. G02B 5/20; G06F 1/16; G06F 3/042

(52) U.S. Cl. CPC G02B 5/208; G06F 3/0421; G06F 3/0428; G06F 1/16
USPC 359/350

(57) ABSTRACT

A reworkable filter structure of infrared touch module includes a main body having an upper protrusion section and an extension section. The upper protrusion section and the extension section respectively angularly extend from an upper end and a lower end of the main body in reverse directions. The upper protrusion section extends to upper sides of multiple infrared transmitters and multiple infrared receivers. The main body is positioned in front of the transmission faces of the infrared transmitters and the receiving faces of the infrared receivers to shield the transmission faces and the receiving faces. The extension section extends to a position between a transparent panel and a second circuit board. The reworkable filter structure further includes a connection means for connecting the extension section of the main body with the second circuit board.

### BACKGROUND OF THE INVENTION

1. Field of the Invention

The present invention relates generally to an infrared filter structure, and more particularly to a filter structure applied to infrared touch module.

2. Description of the Related Art

Infrared touch technique has the advantages of high transparency, sensitivity to the touch of any material and applicability to large-size display. Therefore, infrared touch technique is widely applied to various displays. An infrared touch display screen has infrared transmitters and infrared receivers correspondingly arranged on opposite sides of the surface of the display screen. The infrared transmitters and infrared receivers form an infrared network densely distributed over the surface of the display screen. In touch, the article (such as a finger) will partially interrupt the infrared network to calculate the touch position.

The infrared touch display screen necessitates an infrared transparent frame to ensure that the infrared receiver units receive the infrared rays without interference of the environmental light. Currently, the infrared transparent frame is generally arranged in two manners. According to the first manner, the side frame of the infrared touch display screen is made of an optical material, which is infrared transparent, while visible light nontransparent. According to the second manner, the side frame is made of a nontransparent material and an infrared filter is packaged on the side frame of the infrared touch display screen. In order to lower cost, currently the second manner is most often adopted. The infrared filter is made of a plastic material to which a dye is added. The infrared filters are generally classified into two types. The first type is high-pass filter, which is transparent to the light with a wavelength larger than 850 nm or 940 nm. The second type is low-pass filter, which is transparent to the light with a wavelength within a range from 925 nm to 955 nm.

FIGS. 1A and 1B show the second type of infrared filter. The display screen has a frame body 10. A display section 11 is defined in the frame body 10 corresponding to a display module 12. A transparent panel 13 is overlaid on the display module 12. Two sets of corresponding LED transmitters 14 and LED receivers 15 are arranged on the opposite sides of the frame body 10. The LED transmitters 14 and LED receivers 15 are disposed on a first circuit board 16 and exposed to upper surface of the transparent panel 13. The first circuit board 16 is electrically connected with a second circuit board 17. The first circuit board 16 is an LED circuit board, while the second circuit board 17 is a motherboard. A filter 18 is packaged on the frame body 10. The filter 18 has an upper protrusion section 181 and an extension section 182. The extension section 182 downward extends from a rear end of the upper protrusion section 181 and has a free end 1821. The upper protrusion section 181 extends into the frame body 10 and is positioned on upper side of the LED transmitters 14 and LED receivers 15. The extension section 182 shields the transmission faces of the LED transmitters 14 and the receiving faces of the LED receivers 15 from the affection of the environmental light.

The free end 1821 of the extension section 182 is fixedly adhered to the upper surface of the transparent panel 13 via a first adhesive bar 191. The lower surface of the transparent panel 13 is affixed to the second circuit board 17 via a second adhesive bar 192.

The above arrangement has some shortcomings. For example, the second circuit 17 is affixed to the transparent panel 13 by means of adhesion. In the case that it is necessary to detach the frame body 10 for replacing some components of the infrared touch display screen or repairing the infrared touch display screen, the second circuit board 17 must be separated from the transparent panel 13. Under such circumstance, the circuit or electronic components of the second circuit board 17 may be damaged. In this case, it will be impossible to reuse the second circuit board 17.

### SUMMARY OF THE INVENTION

It is therefore a primary object of the present invention to provide a filter structure of infrared touch module. The filter structure has an extension section adhered to the transparent panel, whereby the filter structure is more securely attached to the transparent panel and prevented from displacing or detaching from the transparent panel.

It is a further object of the present invention to provide the above filter structure. The main body of the filter structure is positioned above and in front of the infrared transmitters and the infrared receivers to shield the same. In addition, the extension section of the filter structure extends to a position between the transparent panel and a circuit board. In this case, the circuit board is not directly adhered to the transparent panel. Accordingly, when separating the circuit board from the transparent panel, the circuit board is prevented from being damaged.

It is still a further object of the present invention to provide the above filter structure, in which the extension section has an upper surface adhered to the transparent panel.

It is still a further object of the present invention to provide the above filter structure, which is applied to an infrared touch module. When separating the circuit board from the transparent panel, the circuit board is prevented from being damaged. Therefore, the infrared touch module is reworkable.

To achieve the above and other objects, the reworkable filter structure of infrared touch module of the present invention is applied to a side frame of the infrared touch module. The side frame has multiple infrared transmitters and multiple infrared receivers. The infrared transmitters and infrared receivers are disposed on a first circuit board. Each infrared transmitter has a transmission face. Each infrared receiver has a receiving face. The first circuit board is connected with a second circuit board. The side frame defines a window therein. A transparent panel is positioned under the side frame in alignment with the window. The transparent panel has a transparent section exposed to the window, a concealed section around the transparent section corresponding to the second circuit board and an outer periphery. The filter structure includes a main body having an upper protrusion section and an extension section. The upper protrusion section and the extension section respectively angularly extend from an upper end and a lower end of the main body in reverse directions. The upper protrusion section extends to upper sides of the infrared transmitters and infrared receivers. The extension section extends to a position between the transparent panel and the second circuit board. The reworkable filter structure further includes a connection means for connecting the extension section of the main body with the second circuit board.

In the above reworkable filter structure of the infrared touch module, the connection means includes a vertical section downward angularly extending from an extension end of the extension section and a horizontal section horizontally extending from one end of the vertical section in parallel to the extension section. A recess is defined between the extension section, the vertical section and the horizontal section. The second circuit board is inserted in the recess.

In the above reworkable filter structure of the infrared touch module, the connection means includes at least one elastic buckle section disposed under the lower surface of the extension section. The elastic buckle section has a neck section and a head section. The second circuit board is formed with at least one perforation corresponding to the elastic buckle section. The head section of the elastic buckle section is passed through the perforation of the second circuit board to fit the neck section in the perforation. Under such circumstance, the head section is engaged with a face of the second circuit board, which face is distal from the extension section to connect the extension section with the second circuit board.

In the above reworkable filter structure of the infrared touch module, the connection means includes at least one socket disposed on the lower surface of the extension section. The second circuit board is formed with at least one perforation corresponding to the socket. At least one fixing member is passed through the perforation into the socket and fixed therein.

According to the above arrangement, the circuit board is not directly adhered to the transparent panel. Therefore, when separating the circuit board from the transparent panel, the circuit board is prevented from being damaged. Moreover, the filter structure is more securely attached to the transparent panel and prevented from displacing or detaching from the transparent panel.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a top view of a conventional infrared touch module;

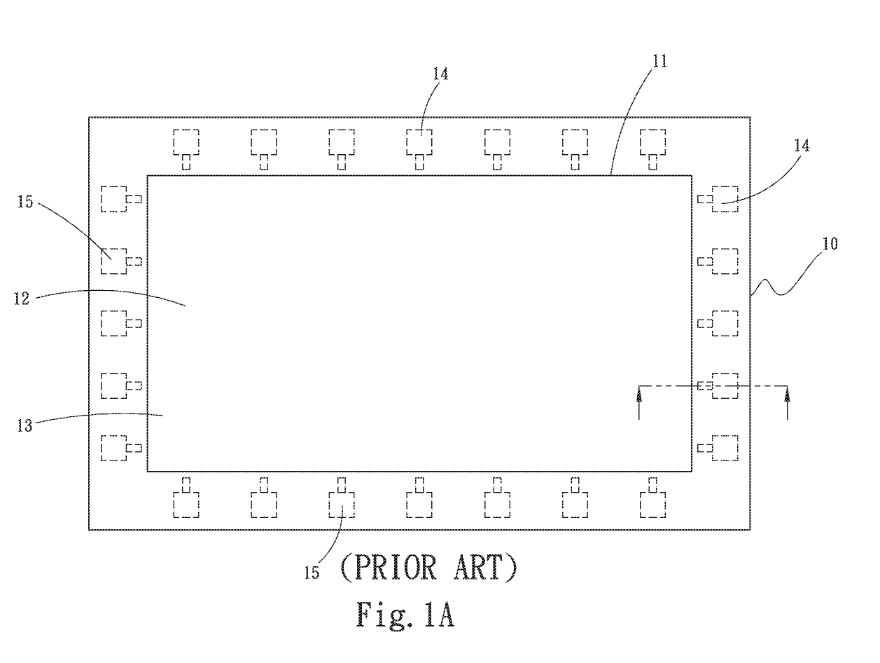

FIG. 1B is a sectional view of a part of the conventional infrared touch module of FIG. 1;

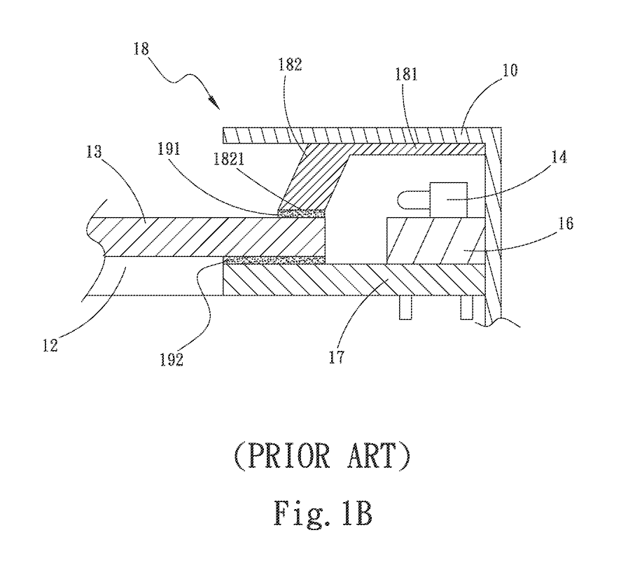

FIG. 2 is a top view of the infrared touch module of the present invention;

FIG. 3A is a sectional view of a first embodiment of the reworkable filter structure of the present invention;

FIG. 3B is a sectional view showing that the first embodiment of the reworkable filter structure of the present invention is applied to an infrared touch module;

FIG. 4A is a sectional view of a second embodiment of the reworkable filter structure of the present invention;

FIG. 4B is a sectional view showing that the second embodiment of the reworkable filter structure of the present invention is applied to an infrared touch module;

FIG. 5A is a sectional view of a third embodiment of the reworkable filter structure of the present invention;

FIG. 5B is a sectional view showing that the third embodiment of the reworkable filter structure of the present invention is applied to an infrared touch module;

FIG. 6A is a sectional view of a fourth embodiment of the reworkable filter structure of the present invention;

FIG. 6B is a sectional view showing that the fourth embodiment of the reworkable filter structure of the present invention is applied to an infrared touch module;

FIG. 7A is a sectional view of a fifth embodiment of the reworkable filter structure of the present invention;

FIG. 7B is a sectional view showing that the fifth embodiment of the reworkable filter structure of the present invention is applied to an infrared touch module;

FIG. 8A is a sectional view of a sixth embodiment of the reworkable filter structure of the present invention; and

FIG. 8B is a sectional view showing that the sixth embodiment of the reworkable filter structure of the present invention is applied to an infrared touch module.

### DETAILED DESCRIPTION OF THE PREFERRED EMBODIMENTS

The embodiments of the present invention will be described hereinafter with reference to the drawings, wherein the same components are denoted with the same reference numerals.

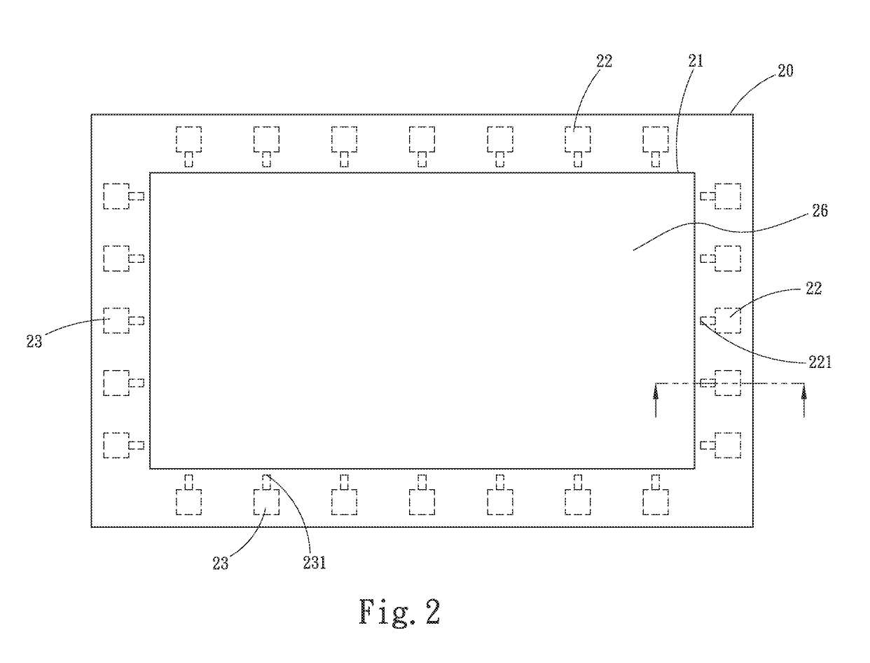

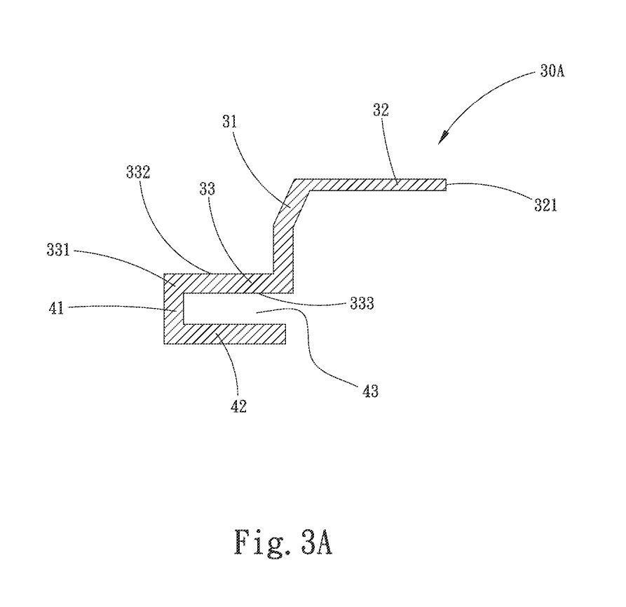

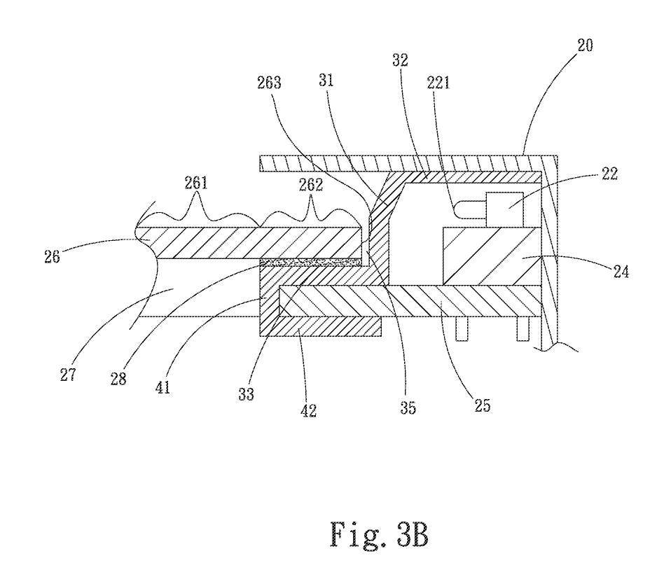

Please refer to FIGS. 2, 3A and 3B. FIG. 2 is a top view of the infrared touch module of the present invention. FIG. 3A is a sectional view of the first embodiment of the filter structure of the present invention. FIG. 3B is a sectional view showing that the first embodiment of the filter structure of the present invention is applied to an infrared touch module.

As shown in FIG. 2, a side frame 20 defines a window 21 therein. Two sets of corresponding infrared transmitters 22 and infrared receivers 23 are arranged on the opposite sides of the frame body 20. The infrared transmitters 22 and infrared receivers 23 are disposed on a first circuit board 24 (as shown in FIG. 3B). The first circuit board 24 is electrically connected with a second circuit board 25 (as shown in FIG. 3B). The first circuit board 24 is an LED circuit board, while the second circuit board 25 is a motherboard. Each infrared transmitter 22 has a transmission face 221 facing a receiving face 231 of each infrared receiver 23. A transparent panel 26 is positioned under the side frame 20 in alignment with the window 21. The infrared transmitters 22 and infrared receivers 23 are exposed to an upper surface of the transparent panel 26 to form an infrared sensing matrix above the transparent panel 26.

As shown in FIGS. 3A and 3B, the transparent panel 26 has a transparent section 261 exposed to the window 21. A display module 27 is positioned under the transparent section 26. The transparent panel 26 further has a concealed section 262 around the transparent section 26 and concealed by the side frame 29 corresponding to the second circuit board 25. The transparent panel 26 further has an outer periphery 263. In this embodiment, the transparent panel 26 is made of such as transparent silica glass, polymethylmethacrylate (PMMA), polycarbonate (PC) or polyethylene terephthalate (PET) for protecting the display module 27. The transparent panel 26 also provides a touch plane, (that is, the upper surface of the transparent panel 26), for a user to touch with a finger or a stylus. The light emitted from the display module 27 (such as an LCD display module) can pass through the transparent panel 26 to present an image to a user.

The filter structure 30A has an upper protrusion section 32 and an extension section 33. The upper protrusion section 32 and the extension section 33 respectively angularly extend from an upper end and a lower end of the main body 31 in reverse directions. The upper protrusion section 32 extends to upper sides of the infrared transmitters 22 and infrared receivers 23. The extension section 33 extends to a position between the transparent panel 26 and the second circuit board 25. The upper protrusion section 32 and the extension section 33 are positioned on different levels. The upper protrusion section 32 has a protrusion end 321 and the extension section 33 has an extension end 331. The main body 31 is positioned in front of the transmission faces 221 of the infrared transmitters 22 and the receiving faces 231 of the infrared receivers 15 to shield the transmission faces 221 and the receiving faces 231. A gap 35 is defined between the outer periphery 263 of the transparent panel 26 and the main body 31.

The extension section 33 between the transparent panel 26 and the second circuit board 25 has an upper surface 332 and a lower surface 333. The upper surface 332 corresponds to the concealed section 262 of the transparent panel 26, while the lower surface 333 corresponds to the second circuit board 25.

A first adhesive layer 28 is disposed between the upper surface 332 of the extension section 33 and the concealed section 262 of the transparent panel 26. The first adhesive layer 28 has adhesion on both faces, whereby the extension section 33 is adhered under the concealed section 262 of the transparent panel 26. The first adhesive layer 28 is such as a double-faced adhesive tape.

The filter structure 30A further has a connection means for connecting the extension section 33 with the second circuit board 25. The connection means includes a vertical section 41 downward angularly extending from the extension end 331 of the extension section 33 and a horizontal section 42 horizontally extending from a rear end of the vertical section 41. The horizontal section 42 is spaced from the extension section 33 in parallel to the extension section 33. A recess 43 is defined between the extension section 33, the vertical section 41 and the horizontal section 42. The recess 43 has a height equal to or slightly larger than a thickness of the second circuit board 25, whereby the second circuit board 25 can be fixedly inserted in the recess 43.

In the case that some components of the infrared touch module are damaged and need to be repaired, a slender and flat tool is inserted into the gap 35 between the outer periphery 263 of the transparent panel 26 and the main body 31 to detach the transparent panel 26 from the second circuit board 25. At this time, the transparent panel 26 may be directly separated from the upper side of the first adhesive layer 28 or under the applied force, the filter structure 30A is broken at a junction between the extension section 33 and the main body 32 and a junction between the extension section 33 and the vertical section 42 to separate the transparent panel 26 from the second circuit board 25. When detached, the second circuit 25 is prevented from being damaged. Therefore, the second circuit board 25 can keep complete. After the reparation is finished, the filter structure 30A is replaced with a new one to recover the infrared touch module.

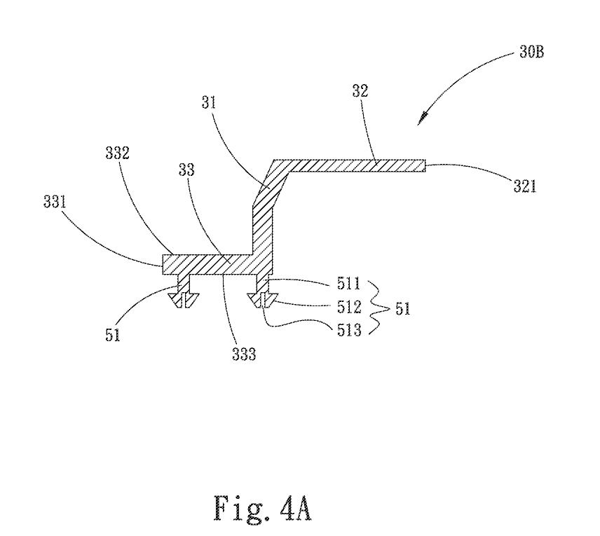

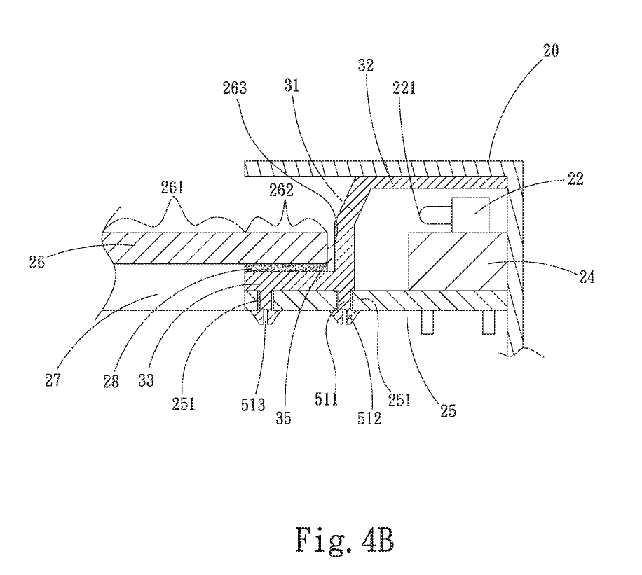

Please now refer to FIGS. 4A and 4B, which show a second embodiment of the filter structure 30B of the present invention. The second embodiment is substantially identical to the first embodiment in structure and thus will not be repeatedly described hereinafter. The second embodiment is different from the first embodiment in that at least one elastic buckle section 51 is disposed under the lower surface 333 of the extension section 33. In this embodiment, there are two elastic buckle sections 51. However, the number of the elastic buckle sections 51 is adjustable according to the length and area of the extension sections 33. The elastic buckle section 51 has a neck section 511 and a head section 512 connected with a free end of the neck section 511. The head section 512 has a conic shape. A large-diameter end of the head section 512 is connected with the free end of the neck section 511. The head section 512 is formed with at least one split 513, whereby the head section 512 is elastically contractible/expandable.

The second circuit board 25 is formed with at least one perforation 251 corresponding to the elastic buckle section 51. In this embodiment, there are two perforations 251. The perforation 251 has a diameter slightly larger than the diameter of the neck section 511, while smaller than the diameter of the large-diameter end of the head section 512. Accordingly, the head section 512 of the elastic buckle section 51 can be passed through the perforation 251 of the second circuit board 25 from one face of the second circuit board 25 to the other face thereof to fit the neck section 511 in the perforation 251. Under such circumstance, the head section 512 is engaged with the other face of the second circuit board 25, whereby the extension section 33 is connected with the second circuit board 25.

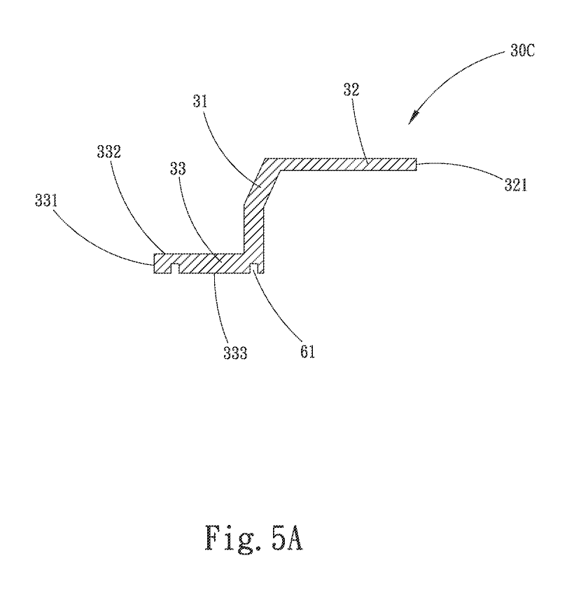

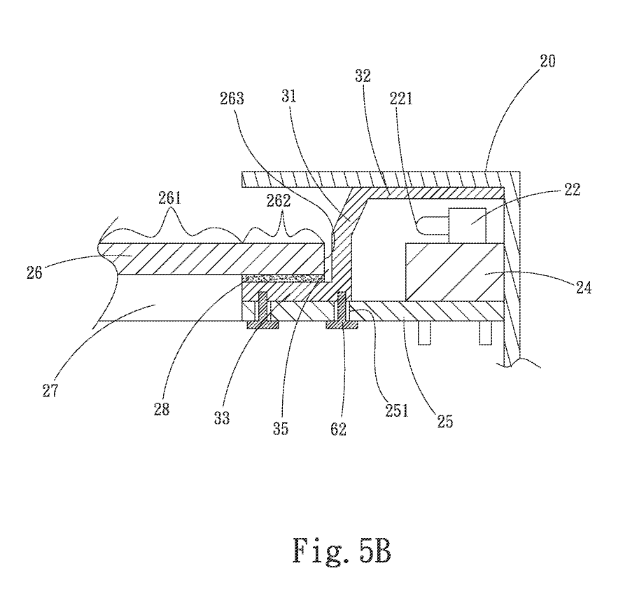

Please now refer to FIGS. 5A and 5B, which show a third embodiment of the filter structure 30C of the present invention. The third embodiment is substantially identical to the first embodiment in structure and thus will not be repeatedly described hereinafter. The third embodiment is different from the first embodiment in that at least one socket 61 is formed on the lower surface 333 of the extension section 33. In this embodiment, there are two sockets 61. The second circuit board 25 is formed with at least one perforation 251 corresponding to the socket 61. In this embodiment, there are two perforations 251. At least one fixing member 62 is passed through the perforation 251 from one face of the second circuit board 25, which face is distal from the extension section 33 into the socket 61 and fixed therein. In this embodiment, there are two fixing members 62. The fixing members 62 are such as screws or the like fixing members.

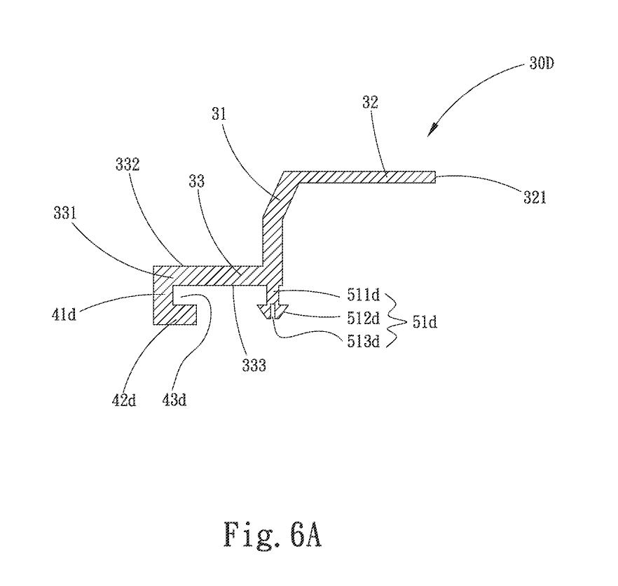

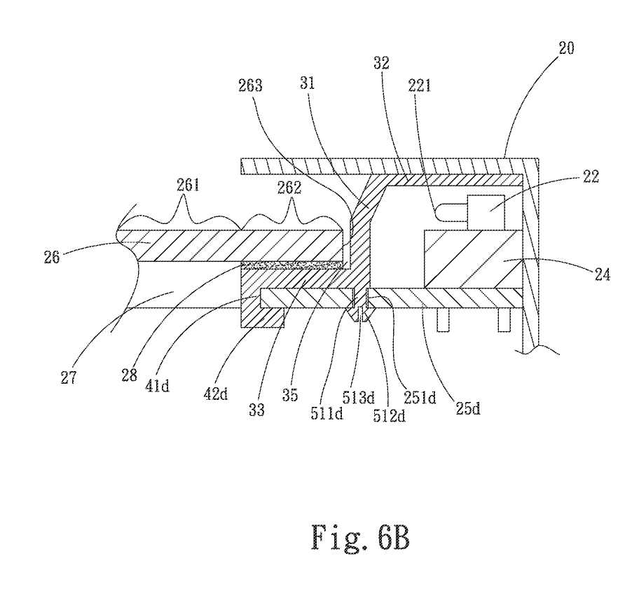

Please now refer to FIGS. 6A and 6B, which show a fourth embodiment of the filter structure 30D of the present invention. The fourth embodiment is substantially identical to the first embodiment in structure and thus will not be repeatedly described hereinafter. The fourth embodiment is different from the first embodiment in that a vertical section 41d downward angularly extends from the extension end 331 of the extension section 33. A horizontal section 42d horizontally extends from a rear end of the vertical section 41d. The horizontal section 42d is spaced from the extension section 33 in parallel to the extension section 33. A recess 43d is defined between the extension section 33, the vertical section 41d and the horizontal section 42d. The recess 43d has a height equal to or slightly larger than a thickness of the second circuit board 25.

At least one elastic buckle section 51d is disposed under the lower surface 333 of the extension section 33. In this embodiment, there is only one elastic buckle section 51. However, the number of the elastic buckle sections 51d is adjustable according to the length and area of the extension sections 33. The elastic buckle section 51d has a neck section 511d and a head section 512d connected with a free end of the neck section 511d. The head section 512d has a conic shape. A large-diameter end of the head section 512d is connected with the free end of the neck section 511d. The head section 512d is formed with at least one split 513d, whereby the head section 512d is elastically contractible/expandable.

One end of the second circuit board 25d is fixedly inserted in the recess 43d. The second circuit board 25d is formed with at least one perforation 251d corresponding to the elastic buckle section 51d. In this embodiment, there is only one perforation 251d. The perforation 251d has a diameter slightly larger than the diameter of the neck section 511d, while smaller than the diameter of the large-diameter end of the head section 512d. Accordingly, the head section 512d of the elastic buckle section 51d can be passed through the perforation 251d of the second circuit board 25d from one face of the second circuit board 25d to the other face thereof to fit the neck section 511d in the perforation 251d. Under such circumstance, the head section 512d is engaged with the other face of the second circuit board 25d, whereby the extension section 33 is fixedly connected with the second circuit board 25d by means of the recess 43d and the elastic buckle section 51d.

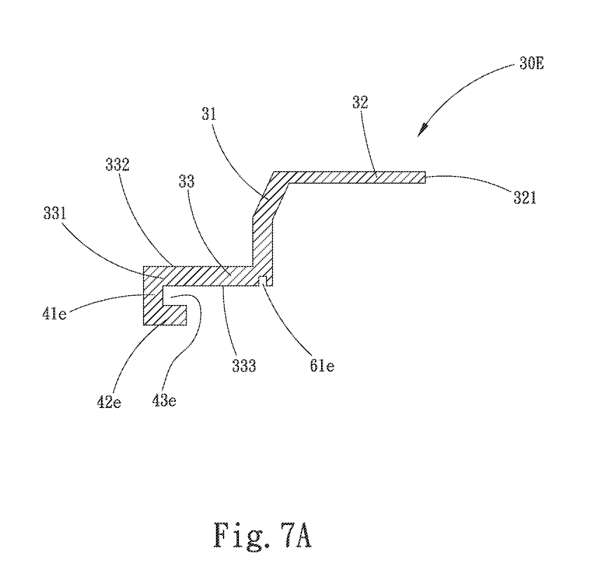

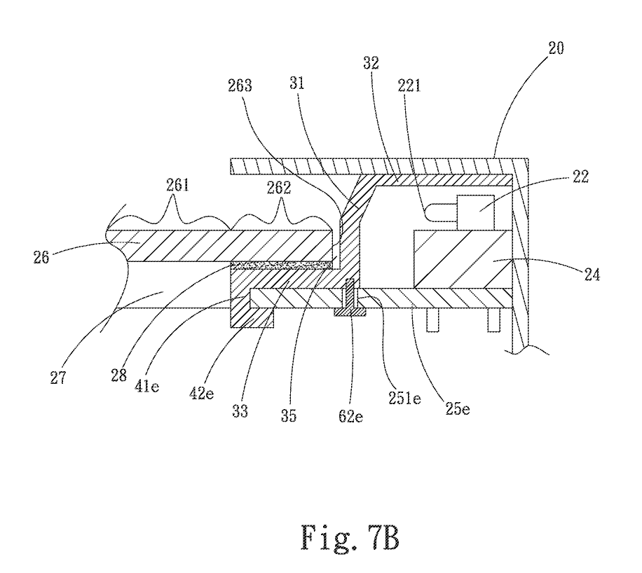

Please now refer to FIGS. 7A and 7B, which show a fifth embodiment of the filter structure 30E of the present invention. The fifth embodiment is substantially identical to the first embodiment in structure and thus will not be repeatedly described hereinafter. The fifth embodiment is different from the first embodiment in that at least one socket 61e is formed on the lower surface 333 of the extension section 33. In this embodiment, there is only one socket 61e. A vertical section 41e downward angularly extends from the extension end 331 of the extension section 33. A horizontal section 42e horizontally extends from a rear end of the vertical section 41e. The horizontal section 42e is spaced from the extension section 33 in parallel to the extension section 33. A recess 43e is defined between the extension section 33, the vertical section 41e and the horizontal section 42e. The recess 43e has a height equal to or slightly larger than a thickness of the second circuit board 25e.

The second circuit board 25e is formed with at least one perforation 251e corresponding to the socket 61e. In this embodiment, there is only one perforation 251e. At least one fixing member 62e is passed through the perforation 251e from one face of the second circuit board 25e, which face is distal from the extension section 33 into the socket 61e and fixed therein. In this embodiment, there is only one fixing member 62e. The fixing member 62e is such as a screw or the like fixing member.

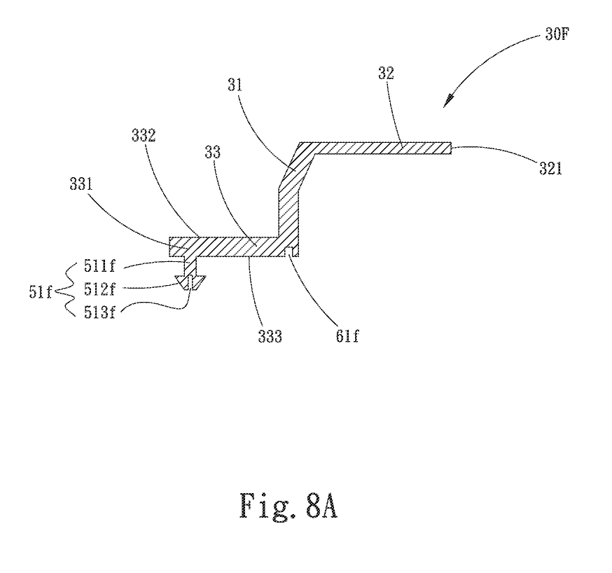

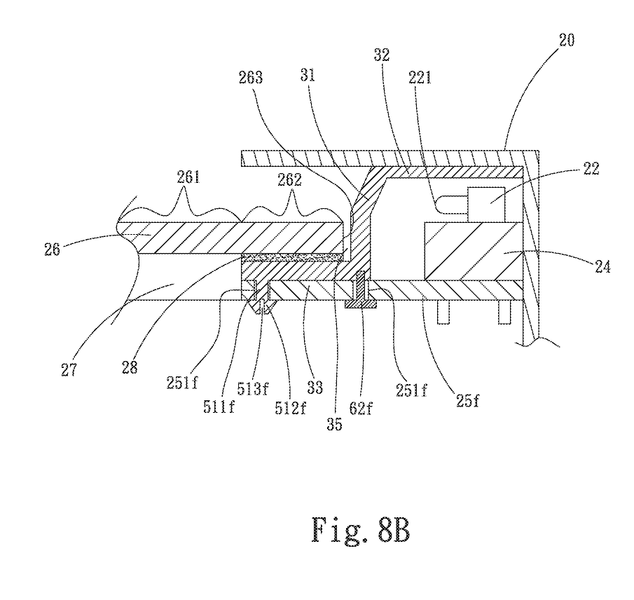

Please now refer to FIGS. 8A and 8B, which show a sixth embodiment of the filter structure 30F of the present invention. The sixth embodiment is substantially identical to the first embodiment in structure and thus will not be repeatedly described hereinafter. The sixth embodiment is different from the first embodiment in that at least one elastic buckle section 51f and at least one socket 61f is disposed on the lower surface 333 of the extension section 33. The elastic buckle section 51f has a neck section 511f and a head section 512f connected with a free end of the neck section 511f. The head section 512f has a conic shape. A large-diameter end of the head section 512f is connected with the free end of the neck section 511f. The head section 512f is formed with at least one split 513f, whereby the head section 512f is elastically contractible/expandable. In this embodiment, there are one elastic buckle section 51f and one socket 61f. However, the number of the elastic buckle sections 51f and the number of the sockets 61f are adjustable according to the length and area of the extension sections 33.

The second circuit board 25f is formed with multiple perforation 251f corresponding to the elastic buckle section 51f and the socket 61f respectively. In this embodiment, there are two perforations 251f. The head section 512f of the elastic buckle section 51f can be passed through one of the perforations 251f of the second circuit board 25f from one face of the second circuit board 25f to the other face thereof to fit the neck section 511f in the perforation 251f. Under such circumstance, the head section 512f is engaged with the other face of the second circuit board 25f.

At least one fixing member 62f is passed through the other of the perforations 251f from one face of the second circuit board 25f, which face is distal from the extension section 33 into the socket 61f and fixed therein. In this embodiment, there is only one fixing member 62f. The fixing member 62f is such as a screw or the like fixing member.

In this embodiment, one side of the second circuit board 25f is buckled with the elastic buckle section 51f and the fixing member 62f is fixed in the socket 61f so that the extension section 33 is securely connected with the second circuit board 25f.

In conclusion, the filter structure of the present invention is positioned above and in front of the infrared transmitters and the infrared receivers to shield the same. The filter structure has an extension section extending between the transparent panel and the circuit board. The filter structure further has a connection means for fixedly connecting the extension section with the second circuit board. The circuit board is not directly adhered to the transparent panel. Accordingly, when separating the circuit board from the transparent panel, the circuit board is prevented from being damaged. In this case, the infrared touch module is repairable and reworkable.

The present invention has been described with the above embodiments thereof and it is understood that many changes and modifications in the above embodiments can be carried out without departing from the scope and the spirit of the invention that is intended to be limited only by the appended claims.

What is claimed is:

1. A reworkable filter structure of infrared touch module, which is applied to a side frame of the infrared touch module, the side frame having multiple infrared transmitters and multiple infrared receivers, the infrared transmitters and infrared receivers being disposed on a first circuit board, each infrared transmitter having a transmission face, each infrared receiver having a receiving face, the first circuit board being connected with a second circuit board, the side frame defining a window therein, a transparent panel being positioned under the side frame in alignment with the window, the transparent panel having a transparent section exposed to the window, a concealed section around the transparent section corresponding to the second circuit board and an outer periphery, the filter structure comprising:
a main body having an upper protrusion section and an extension section, the upper protrusion section and the extension section respectively extending from an upper end and a lower end of the main body in reverse directions, the upper protrusion section extending to upper sides of the infrared transmitters and infrared receivers, the main body shielding the transmission faces of the infrared transmitters and the receiving faces of the infrared receivers, the extension section extending to a position between the transparent panel and the second circuit board; and
a connection means for connecting the extension section of the main body with the second circuit board.

2. The reworkable filter structure of the infrared touch module as claimed in claim 1, wherein the extension section has an upper surface corresponding to the concealed section of the transparent panel and a lower surface corresponding to the second circuit board.

3. The reworkable filter structure of the infrared touch module as claimed in claim 2, wherein a first adhesive layer is disposed between the upper surface of the extension section and the concealed section of the transparent panel.

4. The reworkable filter structure of the infrared touch module as claimed in claim 1, wherein the upper protrusion section and the extension section are positioned on different levels.

5. The reworkable filter structure of the infrared touch module as claimed in claim 1, wherein a gap is defined between the outer periphery of the transparent panel and the main body of the reworkable filter structure.

6. The reworkable filter structure of the infrared touch module as claimed in claim 1, wherein the connection means includes:
a vertical section downward angularly extending from an extension end of the extension section;
a horizontal section horizontally extending from a rear end of the vertical section, the horizontal section being spaced from the extension section in parallel to the extension section; and
a recess defined between the extension section, the vertical section and the horizontal section, the recess having an opening in which the second circuit board is inserted.

7. The reworkable filter structure of the infrared touch module as claimed in claim 1, wherein the connection means includes:
at least one elastic buckle section disposed under a lower surface of the extension section, the elastic buckle section having a neck section and a head section; and
at least one perforation formed on the second circuit board corresponding to the elastic buckle section, the head section of the elastic buckle section being passed through the perforation of the second circuit board to fit the neck section in the perforation, whereby the head section is engaged with a face of the second circuit board, which face is distal from the extension section to connect the extension section with the second circuit board.

8. The reworkable filter structure of the infrared touch module as claimed in claim 1, wherein the connection means includes:
at least one socket disposed on a lower surface of the extension section;
at least one perforation formed on the second circuit board corresponding to the socket; and
at least one fixing member passed through the perforation into the socket and fixed therein.

9. The reworkable filter structure of the infrared touch module as claimed in claim 1, wherein the connection means includes:
a vertical section downward angularly extending from an extension end of the extension section;
a horizontal section horizontally extending from a rear end of the vertical section, the horizontal section being spaced from the extension section in parallel to the extension section; and
a recess defined between the extension section, the vertical section and the horizontal section, the recess having an opening in which the second circuit board is inserted;
at least one elastic buckle section disposed under a lower surface of the extension section, the elastic buckle section having a neck section and a head section; and
at least one perforation formed on the second circuit board corresponding to the elastic buckle section, the head section of the elastic buckle section being passed through the perforation of the second circuit board to fit the neck section in the perforation, whereby the head section is engaged with a face of the second circuit board, which face is distal from the extension section to connect the extension section with the second circuit board.

10. The reworkable filter structure of the infrared touch module as claimed in claim 1, wherein the connection means includes:
a vertical section downward angularly extending from an extension end of the extension section;
a horizontal section horizontally extending from a rear end of the vertical section, the horizontal section being spaced from the extension section in parallel to the extension section; and
a recess defined between the extension section, the vertical section and the horizontal section, the recess having an opening in which the second circuit board is inserted;
at least one socket disposed on a lower surface of the extension section;
at least one perforation formed on the second circuit board corresponding to the socket; and
at least one fixing member passed through the perforation into the socket and fixed therein.

11. The reworkable filter structure of the infrared touch module as claimed in claim 1, wherein the connection means includes:
at least one elastic buckle section disposed under a lower surface of the extension section, the elastic buckle section having a neck section and a head section;
at least one socket disposed on a lower surface of the extension section; and
multiple perforations formed on the second circuit board corresponding to the elastic buckle section and the socket respectively, the head section of the elastic buckle section being passed through the perforation of the second circuit board to fit the neck section in the perforation, whereby the head section is engaged with a face of the second circuit board, which face is distal from the extension section to connect the extension section with the second circuit board, the connection means further including at least one fixing member passed through the perforation into the socket and fixed therein.
